(19) United States
(12) Patent Application Publication
(10) Pub. No.: US 2006/0144451 A1
(43) Pub. Date: Jul. 6, 2006

(54) Hydraulic pressure control device

(75) Inventor: Tomohiro Satoh, Toyoake-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/810,888

(22) Filed: Mar. 29, 2004

(30) Foreign Application Priority Data
Mar. 28, 2003 (JP) 2003-092878

(51) Int. Cl. F15B 13/04

(52) U.S. Cl. 137/625.69

(57) ABSTRACT

A hydraulic pressure control device includes a cylindrical valve body, at least one opening portion provided on the valve body, a spool valve disposed in the valve body and slidable along an inner surface of the valve body, at least one land portion provided at the spool valve and slidable along the inner surface of the valve body, and at least one recess provided at land portion of the spool valve wherein opening width of the recess continuously changes in sliding direction of the spool valve.

### CROSS REFERENCE TO RELATED APPLICATIONS

This application is based on and claims priority under 35 U.S.C. §119 with respect to a Japanese Patent Application 2003-092878, filed on Mar. 28, 2003, the entire content of which is incorporated herein by reference.

### FIELD OF THE INVENTION

The present invention generally relates to a hydraulic pressure control valve.

### BACKGROUND OF THE INVENTION

Control valve of hydraulic commonly comprises a valve body formed with cylindrical shape having a plurality of ports and a spool valve slidably provided in the valve body. The spool valve includes at least one land portion wherein outer surface of the land portion slidably contacts to inner surface of the valve body. Hydraulic pressure and flow volume are controlled according to change of opening area of the ports by sliding the spool valve.

For example, when the port (wherein the hydraulic fluid is supplied into hydraulic fluid control valve) is shut, flow volume of the supplied hydraulic fluid becomes approximately zero. The flow volume is suddenly increased at the moment of opening of the port wherein the spool valve slides and edge portion of the land opens the port. Consequently, hydraulic shock is taken place. If small quantity of flow volume is required, controlling of the hydraulic becomes difficult.

To decrease the hydraulic shock in small quantity of flow volume for a hydraulic control valve, a method with the use of recess is disclosed in Japanese Patent Laid-Open Publication No. H10-252903. In this method, at least one recess having straight or half circle shape is provided at edge portion of the land. Function of the recess is to decrease opening area of the port for small quantity of flow volume.

However, opening area of recess is changed in incremental steps for disclosed method. FIG. 5 shows relationship between stroke of the spool valve and flow volume of the hydraulic fluid wherein a broken line corresponds to the case of disclosed method using recess. The flow volume is not increased smoothly with the stroke of the spool valve.

### SUMMARY OF THE INVENTION

In light of foregoing, according to an aspect of the present invention, a hydraulic pressure control valve includes a cylindrical valve body, at least one opening portion provided on the valve body, a spool valve disposed in the valve body and slidable along an inner surface of the valve body, at least one land portion provided at the spool valve and slidable along the inner surface of the valve body, and at least one recess provided at an edge of the land portion of the spool valve wherein cross-sectional opening area between the recess and the inner surface of the valve body continuously changes in sliding direction of the spool valve.

It is preferable that the cross-sectional opening area between the recess and the inner surface of the valve body is continuously decreased in sliding direction of the spool valve from an edge portion of the land portion.

It is preferable that the cross-sectional opening area of the recess is formed to have a proportional relationship between flow quantity of a hydraulic fluid and moving distance of the spool valve.

It is preferable that a plurality of recesses are provided at each land portion corresponding to the opening portion of the valve body.

It is preferable that the recess is formed by machining of the land portion using a T-slot cutter, and working edge of the T-slot cutter is shaped in accordance with shape of the recess.

### BRIEF DESCRIPTION OF THE DRAWING FIGURES

The foregoing and additional features and property of the present invention will become more apparent from the following detailed description considered with reference to the accompanying drawing figures wherein:

FIG. 1 is a block diagram showing a configuration of a hydraulic pressure control valve for automatic transmission according to a first embodiment of the present invention;

FIG. 2 is a cross sectional view schematically illustrating correlation between control valve and clutch of hydraulic pressure control valve for automatic transmission according to the first embodiment of the present invention;

FIG. 3 is a partial cross sectional view schematically illustrating control valve according to the first embodiment of the present invention;

FIG. 4 is a partial cross sectional view schematically illustrating operation of control valve according to the first embodiment of the present invention;

FIG. 5 shows flow volume change curve of hydraulic fluid with operation of control valve under a constant pressure according to the first embodiment of the present invention;

FIG. 6 shows common relationship between flow volume and orifice area under a constant pressure;

FIG. 7 is an explanation drawing of a machine tool for manufacturing a spool valve and manufacturing method of a spool valve according to the first embodiment of the present invention;

FIG. 8 shows flow volume change of hydraulic fluid with operation of control valve according to the first embodiment of the present invention; and

FIG. 9 is a cross sectional view schematically illustrating control valve of hydraulic pressure control valve for automatic transmission according to a second embodiment of the present invention.

### DETAILED DESCRIPTION OF THE INVENTION

A preferred embodiment of the present invention will be described hereinbelow in detail with reference to the accompanying drawings.

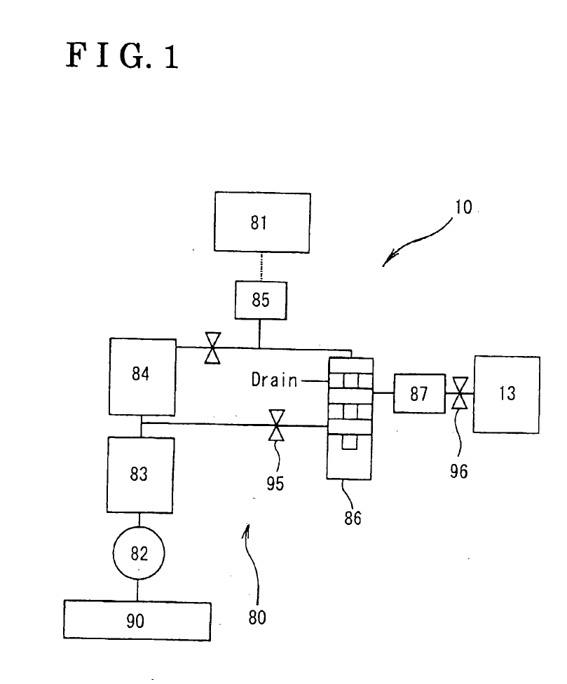

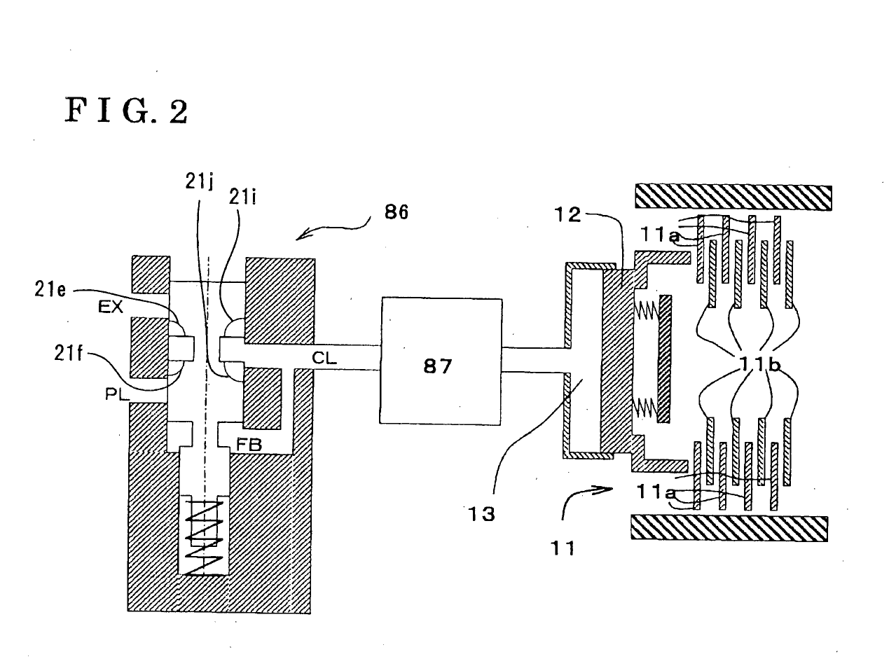

A first embodiment of the present invention is explained referring to FIGS. 1 to 8. As shown in FIG. 1 to FIG. 3, a hydraulic pressure control valve 10 includes a clutch device 11 (a friction engagement means) including drive rotor 11a and driven rotor 11b, a piston 12 (shown in FIG. 2) pushing the drive rotor 11a to be in engagement with the driven rotor 11b, a hydraulic pressure chamber 13 defined by the piston 12 for changing a pushing force of the piston 12 in response to provided hydraulic pressure, and a hydraulic pressure control mechanism 80 controlling hydraulic pressure provided to the hydraulic pressure chamber 13. Accordingly, a transmission (not shown) is shifted with engaging and disengaging the drive rotor 11a and the driven rotor 11b.

As shown in FIG. 1, the hydraulic pressure control mechanism 80 includes an fluid pump 82 which pumps up hydraulic fluid from a strainer 90 and functions as a origin of hydraulic pressure, a regulator valve 83 regulating the hydraulic pressure generated at the fluid pump 82, a modulator valve 84 for depressurization of the hydraulic pressure, a linier solenoid valve 85 regulating the hydraulic pressure from the modulator valve 84, a control valve 86 regulating line pressure provided from the regulator valve 83 based on the hydraulic pressure regulated by the linier solenoid valve 85 and providing the hydraulic fluid to the hydraulic pressure chamber 13, and a shift valve 87 changing flow path of the hydraulic fluid from the control valve 86. To make flow path resistance constant, a flow path from the regulator valve 83 to the control valve 86 and a flow path from the control valve 86 to the hydraulic pressure chamber 13 has a cross sectional area exceeding predetermined cross sectional area, and orifices 95, 96 are provided. An electric control unit (ECU) 81 controls supply of hydraulic pressure to the clutch device 11 and another plurality of clutch device (not shown) to make it required shift condition of an automatic transmission with consideration of a vehicle condition.

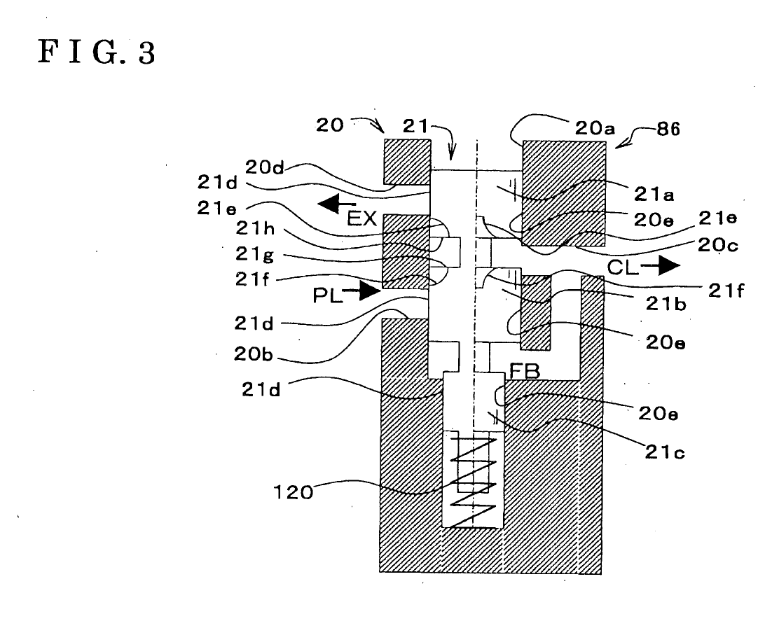

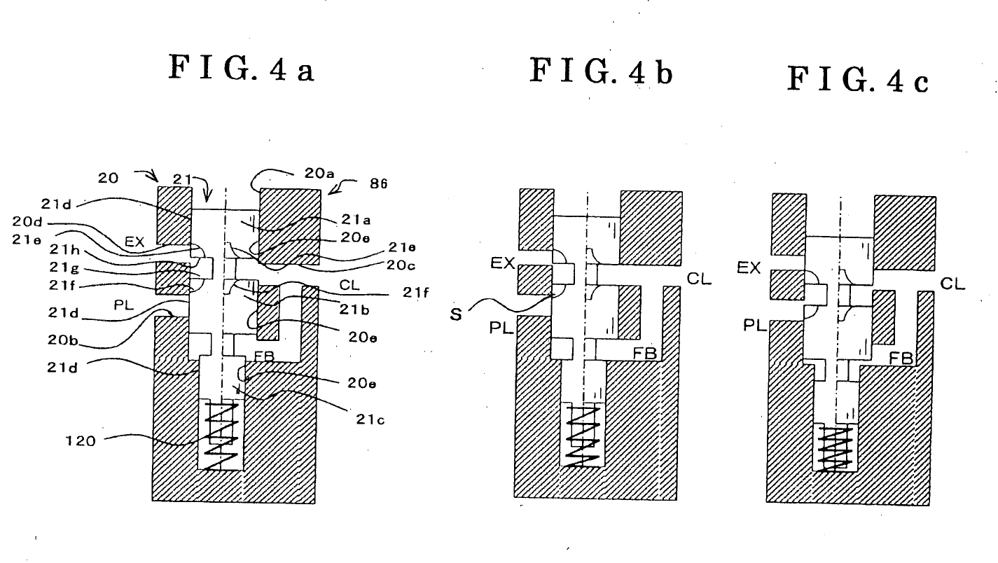

As shown in FIG. 3, the control valve 86 mainly includes a valve body 20 and a spool valve 21 slidably provided in the valve body 20. FIG. 3 (and FIG. 4 also) is partial cross sectional view of the control valve 86.

The valve body 20 is formed as cylindrical shape. Plurality of ports (opening portion) 20b, 20c, 20d are formed at the wall 20a of the valve body 20. Plurality of ports 20b, 20c, 20d include a line port 20b (port) wherein the hydraulic fluid is supplied from the regulator valve 83, a supply port 20c (port) supplying the hydraulic fluid to the hydraulic pressure chamber 13 through the shift valve 87, and a drain port 20d (port).

The spool valve 21 slides up-and-down direction in the valve body 20 as shown in FIG. 3. In FIG. 3 (and FIG. 4 also), appearance of the spool valve is divided at a center line (dashed line). Namely, left side shows cross sectional view of the spool valve 21, and right side shows normal view of the spool valve 21. In particular, the right side of the spool valve 21 is viewed from left side to the direction of arrow PL in FIG. 3.

Three lands (land portion) 21a, 21b, 21c are formed along the sliding direction of the spool valve 21. Outer surface 21d of each land 21a, 21b, 21c are slidably contacting with inner surface 20e of the valve body. The outer surface 21d of the land 21a, 21b changes opening area of the line port 20b, the supply port 20c, and the drain port 20d corresponding to position of the spool valve 21 to the valve body 20. Thus, the hydraulic pressure and flow volume of the hydraulic fluid supplied to hydraulic pressure chamber 13 can be controlled by controlling opening area of ports 20b, 20c, 20d. A solenoid (not shown), a spring 120 and the hydraulic pressure controls physical relationship between the spool valve 21 and the valve body.

Next, shape of recesses 21e, 21f, 21i, and 21j will be explained. Recesses are provided at each land portion of corresponding position to each port. As shown in FIG. 3, the recess 21e is provided at lower edge portion 21h of the land 21a. Also, the recess 21f is provided at upper edge portion 21g of the land 21b. Additionally, the recess 21i is provided at lower edge portion 21h of the land 21a, and the recess 21j is provided at upper edge portion 21g of the land 21b (shown in FIG. 2). Since the recesses 21e, 21f, 21i, and 21j are formed with same method in the present embodiment, the forming method is explained for the recess 21f as a representative of recesses 21e, 21f, 21i, and 21j.

The shape of the recess 21f is determined based on following principle explained.

FIG. 6 shows the relationship between flow volume Q of the hydraulic fluid and opening area A of an orifice (orifice area A) provided in the flow path wherein cross sectional area of the flow path (without orifice) and oil pressure are considered as constant. Flow characteristic of common hydraulic fluid is that the flow volume Q gradually increases with the orifice area A at small orifice area, and change quantity of the flow volume Q gets small with increase of the orifice area, and finally the flow volume reaches constant value. When the opening area of the orifice is extended in constant change quantity, flow volume of the hydraulic fluid through the orifice can not change in proportion to the orifice area. Thus, to obtain constant change of the flow volume of the hydraulic fluid, opening area of the orifice may be changed with small quantity at a region of small orifice area, and get large more and more at a region of large orifice area.

In the first embodiment of the present invention, opening width of the recess 21f is formed with changing depending on its location. The opening width of the recess 21f is the widest at the upper edge portion 21g of the land 21b, and it turns into narrow concurrent with the position getting down from upper edge portion 21g of the land 21.

The opening width of the recess 21f is set by following method as an example. First, relationship between flow volume Q and orifice area A is experimentally obtained as shown in FIG. 6. Next, a polynomial approximated function is calculated using regression analysis of data, and an inverse function is calculated from the polynomial approximated function. Finally, shape of the recess is determined by applying the inverse function.

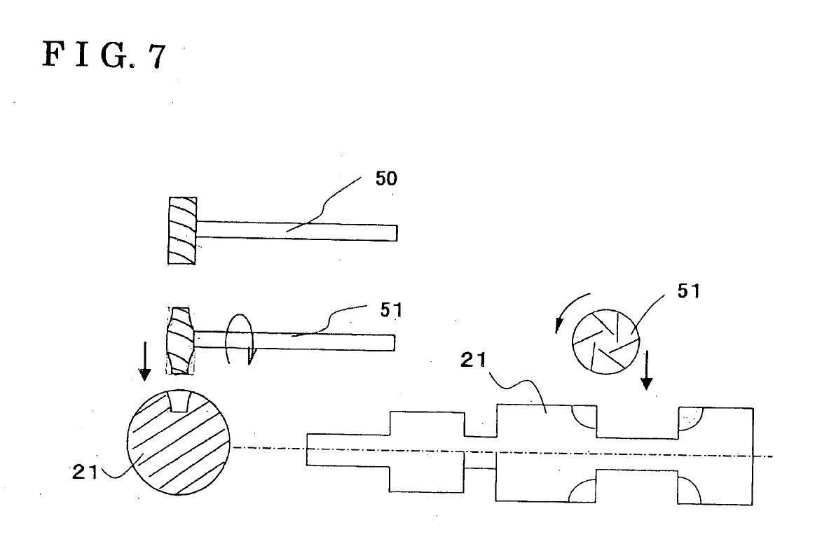

Machining method of the recess 21f is explained referring to FIG. 7. For example, a commercial T-slot cutter 50 may be used to machine the recess having given shape. Both sides of cutting tooth of the commercial T-slot cutter 50 are ground to make a practical T-slot cutter 51 with corresponding shape of the recess 21f. The recess 21f is cut using rotating T-slot cutter 51.

Next, action of the hydraulic fluid control device 10 for automatic transmission according to a first embodiment of the present invention is explained.

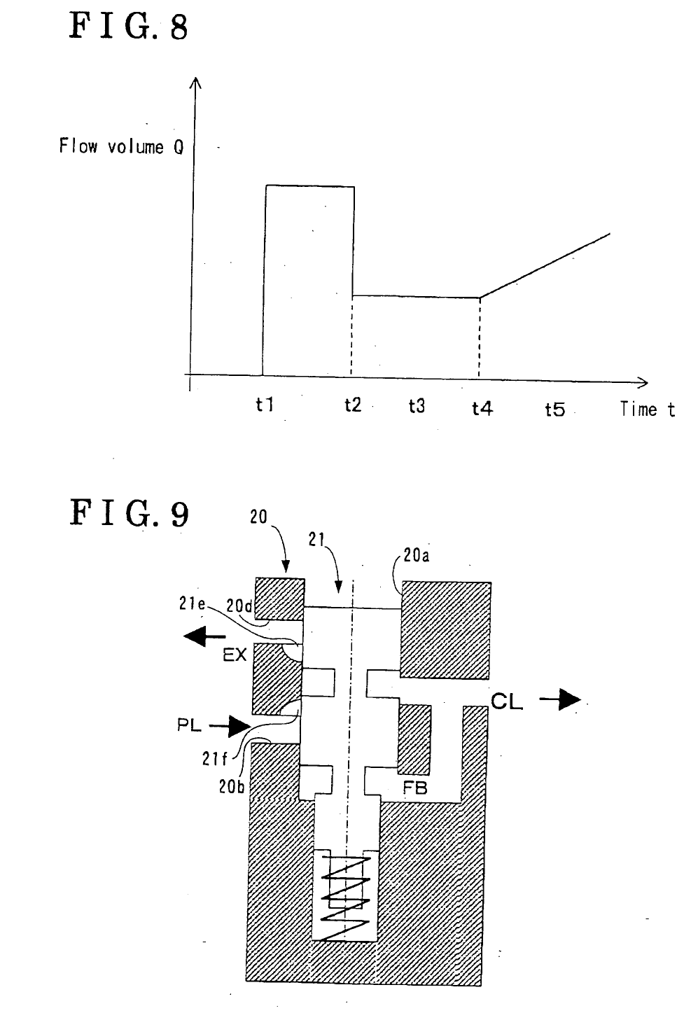

FIG. 8 shows flow volume change of the hydraulic fluid according a situation from disengagement state to engagement state of the clutch 11. When the hydraulic fluid is supplied to the hydraulic pressure chamber 13 by the hydraulic pressure control mechanism 80 at disengaged state of the clutch 11, the piston 12 is pushed and moved into clutch 11 side. At starting stage of shift change, high flow volume of the hydraulic fluid is supplied to the hydraulic pressure chamber 13 from t1 to t2 to move the piston 12 quickly. Then, low flow volume of the hydraulic fluid is supplied to the hydraulic pressure chamber 13 between t2 and t4 to move the piston 12 to get close to the clutch 11 gradually. At the point of t4, the clutch 11 is in partial clutch engagement state. After that, the flow volume of the hydraulic fluid is linearly increased with time, and state of the clutch 11 is changed from partial clutch engagement state (at t4) to engagement state (at t5). Then, predetermined hydraulic fluid pressure is kept after t5 to keep engagement state of the clutch 11.

Next, action of the control valve 86 and supplied flow volume of the hydraulic fluid to the hydraulic pressure chamber 13 will be explained.

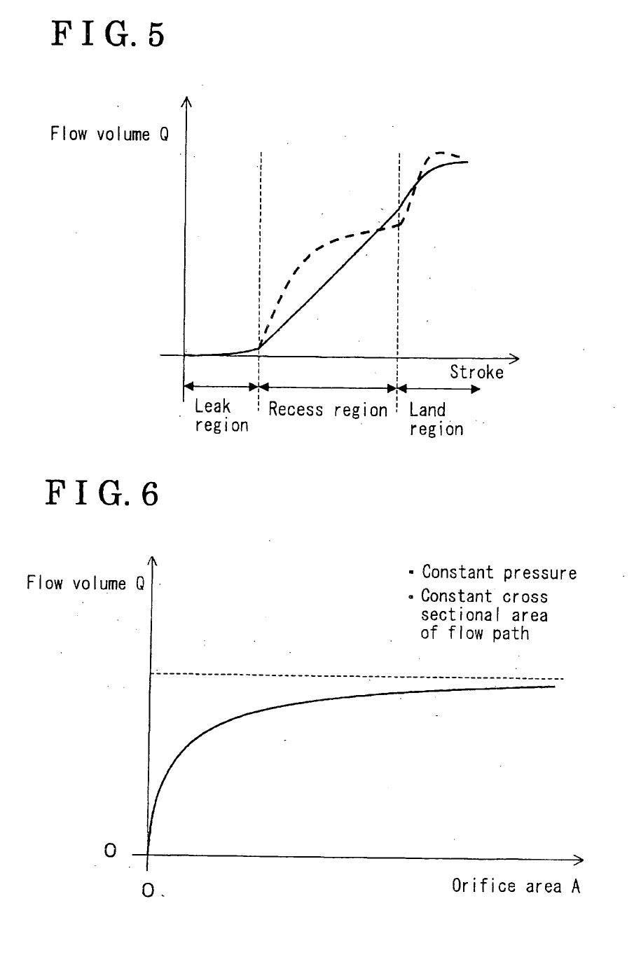

FIG. 4a shows that the outer surface 21d of the land 21b closes the line port 20b. In this situation, the supply port 20c and the drain port 20d are in opened condition, and flow volume to the hydraulic pressure chamber 13 is approximately zero. This situation is referred to as leak region (shown in FIG. 5).

When the spool valve 21 slides from the state of the leak region to downward in FIG. 4, as shown in FIG. 4b, the spool valve 21 slides with that the recess 21f passes over the line port 20b. This situation is referred to as recess region (shown in FIG. 5). In the recess region, the hydraulic fluid flows from the line port 20b to the valve body 20 through the opening area S of the line port 20b.

Furthermore, when the spool valve 21 slides from the state of the recess region to downward in FIG. 4, as shown in FIG. 4c, the spool valve 21 slides with that the upper edge portion 21g of the land 21b passes over the line port 20b. This situation is referred to as land region (shown in FIG. 5).

FIG. 5 shows relationship between slide stroke (horizontal axis) and supplied flow volume to the hydraulic pressure chamber 13 (vertical axis) for the first embodiment. The slide stroke is a positional change from the leak region to the recess region and more the land region.

As described above, the hydraulic fluid flows from the line port 20b to the valve body 20 through the opening area S of the line port 20b in the recess region. In the first embodiment of the present invention, since the recess 21f is provided at the edge portion 21g of the land 21b, rapid increase in opening area S can be prevented with changing from the leak region to the recess region. Thus, the flow volume of the hydraulic fluid can be smoothly changed with stroke of the spool valve 21.

In the first embodiment of the present invention, although recesses are provided at each land portion of corresponding position to each port, number of recess is not limited to this configuration. Namely, number of recess may be set to another number in case that sum of port opening area is determined so as to attain smooth change in the flow volume.

A second embodiment of the present invention is explained referring to FIG. 9. In the second embodiment, recess 21e is provided at a corner crossing the drain port 20d and the wall 20a of the valve body 20, and also, recess 21f is provided at a corner crossing the line port 20b and the wall 20a of the valve body 20. Opening width of recesses 21e, 21f is continuously decreased in sliding direction of the spool valve 21 from inner wall surface of the drain port 20d or the line port 20b. The other structure member is essentially equivalent with the first embodiment. Accordingly, the flow volume of the hydraulic fluid can be smoothly changed with stroke of the spool valve 21 even in this configuration.

The principles, a preferred embodiment and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. A hydraulic pressure control device, comprising:
a cylindrical valve body;
at least one opening portion provided on the valve body;
a spool valve disposed in the valve body and slidable along an inner surface of the valve body;
at least one land portion provided at the spool valve and slidable along the inner surface of the valve body; and
at least one recess provided at an edge of the land portion of the spool valve;
wherein cross-sectional opening area between the recess and the inner surface of the valve body continuously changes in sliding direction of the spool valve.

2. A hydraulic pressure control device according to claim 1, wherein the cross-sectional opening area between the recess and the inner surface of the valve body is continuously decreased in sliding direction of the spool valve from the edge portion of the land portion.

3. A hydraulic pressure control device according to claim 1, wherein the cross-sectional opening area of the recess is formed to have a proportional relationship between flow quantity of a hydraulic fluid and moving distance of the spool valve.

4. A hydraulic pressure control device according to claim 1, wherein a plurality of recesses are provided at each land portion corresponding to the opening portion of the valve body.

5. A hydraulic pressure control device according to claim 1, wherein the recess is formed by machining of the land portion using a T-slot cutter, and working edge of the T-slot cutter is shaped in accordance with shape of the recess.

6. A hydraulic pressure control device, comprising:
a cylindrical valve body;
at least one opening portion provided on the valve body;
a spool valve disposed in the valve body and slidable along an inner surface of the valve body;
at least one land portion provided at the spool valve and slidable along the inner surface of the valve body; and
at least one recess provided at a wall of the inner surface of the valve body facing the outer surface of the spool valve;
wherein the cross-sectional opening area between the recess and the outer surface of the spool valve is continuously decreased in sliding direction of the spool valve from the opening portion.

7. A hydraulic pressure control device, comprising:
a friction engagement means including a drive rotor and a driven rotor;
a piston pushing a plurality of clutch discs between the drive rotor and driven rotor and engaging the drive rotor with the driven rotor;
a hydraulic pressure chamber defined by the hydraulic pressure for changing a pushing force of the piston;
a hydraulic pressure control mechanism controlling hydraulic pressure to be supplied to the hydraulic pressure chamber;
a cylindrical valve body provided at the hydraulic pressure control mechanism;
at least one opening portion provided on the valve body;
a spool valve disposed in the valve body and slidable along an inner surface of the valve body;
at least one land portion provided at the spool valve and slidable along the inner surface of the valve body; and
at least one recess provided at an edge of the land portion of the spool valve;
wherein cross-sectional opening area between the recess and the inner surface of the valve body continuously changes in sliding direction of the spool valve.

8. A hydraulic pressure control device, comprising:
a friction engagement means including a drive rotor and a driven rotor;
a piston pushing a plurality of clutch discs between the drive rotor and driven rotor and engaging the drive rotor with the driven rotor;
a hydraulic pressure chamber defined by the hydraulic pressure p for changing a pushing force of the piston;
a hydraulic pressure control mechanism controlling hydraulic pressure to be supplied to the hydraulic pressure chamber;
a cylindrical valve body provided at the hydraulic pressure control mechanism;
at least one opening portion provided on the valve body;
a spool valve disposed in the valve body and slidable along an inner surface of the valve body;
at least one land portion provided at the spool valve and slidable along the inner surface of the valve body; and
at least one recess provided at a wall of the inner surface of the valve body facing the outer surface of the spool valve;
wherein the cross-sectional opening area between the recess and the outer surface of the spool valve is continuously decreased in sliding direction of the spool valve from the opening portion.
